(19) United States
(12) Patent Application Publication
(10) Pub. No.: US 2012/0263344 A1
(43) Pub. Date: Oct. 18, 2012

(54) MEASURING APPARATUS AND METHOD FOR DETERMINING AT LEAST OF THE CRIMP HEIGHT OF A CONDUCTOR CRIMP

(76) Inventor: Stefan Viviroli, Horw (CH)

(21) Appl. No.: 13/445,170

(22) Filed: Apr. 12, 2012

(30) Foreign Application Priority Data
Apr. 12, 2011 (EP) 11162082.9

(51) Int. Cl. G06K 9/00

(52) U.S. Cl. 382/100

(57) ABSTRACT

A measuring arrangement (50) for measuring a conductor crimp (18.1) of a crimp contact (30) in a measurement area (53) consists essentially of a camera (20), a measuring instrument (1), and a vision system. By means of a mirror arrangement (51), the crimp contact is illustrated from below and from the side in the camera (20) and the position of the crimp contact in the measurement area (53) is evaluated. With the measurement instrument (1), the crimp height (18.1) of the conductor crimp is measurable. When the position of the crimp contact (30) in the measurement area (53) is correct, the crimp height of the conductor crimp (18.1) is measured.

The invention relates to a measuring arrangement for determining at least the crimp height of a conductor crimp of a crimp contact.

“Crimping” is to be understood as the creation of an unreleasable electrical and mechanical connection between a conductor and a contact. When crimping, the crimp height of the conductor crimp is a central criterion for evaluating the quality of the crimp connection. Based on the cross-sectional shape of the conductor crimp, the crimp height is determined as the distance between a measuring point and a measuring blade. The crimp height is often measured manually on the wire-processing machine, or at a special measuring location, for example with a micrometer or with a measuring apparatus that is fitted with a digital dial gauge.

Although the accuracy of such a measurement is adequate, in practice it is usually limited by operating faults or deliberate manipulations by the operator. The required measurement accuracy can therefore often not be reliably attained. For example, the operator can measure at an incorrect place, or not hold the contact straight in the measuring apparatus. Increasing miniaturization additionally hinders the performance of a correct measurement. It is also difficult for the operator to recognize faulty measurements as such.

Besides apparatuses for manual measurement of the crimp height, solutions also exist for automatic measurement in which the wire is brought to the measurement apparatus through the machine.

From patent EP 1 780 846 B1 a measuring device for determining the crimp height has become known. A measuring head consists of an upper part and a lower part which can be moved together by means of arms. The upper part is equipped with a force-measuring device, a centering device for the horizontal centering of a conductor crimp, and a first blade. The lower part consists of a point and a second blade. On closing the measuring head, the position of the conductor crimp is corrected my means of the blades and the centering plates. By means of the point and of the first blade, the height of the conductor crimp, or crimp height respectively, is measurable, the force-measuring device determining the gripping force between point, conductor crimp and first blade.

It is therefore a task of the present invention to avoid the disadvantages of the known, and in particular to create a measuring arrangement and a procedure in which at least the crimp height of a conductor crimp is reliably determinable.

According to the invention, these tasks are solved with the measuring arrangement and the procedure with the characteristics of the independent claims.

The vision system can comprise an evaluation and comparison device, with which, based on the images taken by the camera, the actual position of the crimp contact is determined and the actual position can be compared with a reference position of the crimp contact.

The vision system can be programmed in such manner that a measurement of the crimp height of the conductor crimp is only performed by the measuring apparatus when all predetermined requirements for the position of the crimp contact are fulfilled.

For tactile measurement, the measurement apparatus can have measuring sensors which are situated mutually opposite and are movable relative to each other by means of an actuator. Of these, at least for the measuring operation, one measuring sensor can be embodied stationary and the other measuring sensor movably. Self-evidently, both measuring sensors could also be embodied movably.

The vision system that is connected with the actuator can be programmed in such manner that on absence of the predefined requirements for the position of the crimp contact, or if the predefined requirements for the position of the crimp contact are not fulfilled, while the conductor crimp that is present in the measuring area is contacted by the measuring sensor, the measuring sensors automatically move back into a rest position.

If the measuring arrangement has a mirror arrangement, with whose assistance images of various views of the crimp contact can be taken by the camera, it can be advantageous if the measuring apparatus contains as first measuring sensor a blade which abuts against the first and second mirror at right angles and is arranged between the first and second mirror.

Further advantageous further developments of the invention are stated in the dependent patent claims.

To improve the measurement process, the measuring arrangement is assisted by a camera system which preferably partly or wholly automates, monitors, visualizes, and protocols the measuring process.

At least one image sensor of a camera takes images of the conductor crimp that is arranged in the measuring area as the measurement object that is to be measured. A vision system evaluates the images of the image sensor according to a certain procedure and decides when a measurement object is located in a valid measuring position and then initiates a measurement at least of the crimp height that is independent of the images.

When measuring the crimp height as first parameter, for this purpose the mutually oppositely situated measuring sensors (e.g. measuring point, measuring blade) can be moved towards each other. The measuring apparatus could also have other means for tactile measurement of the crimp height. For example, at a predefined gripping force, the measurement value is read from a dial gauge or from a height-measuring instrument. To keep the deceleration on moving the measurement sensors together low, the stroke of the measurement point can be adjustable.

From the images, further criteria can also be analyzed with which the validity of the measurement is determinable and with which, if necessary, the measurement can be subsequently rejected, for example if the conductor crimp or another measurement object does not lie exactly perpendicular to the measurement axis.

If, as is today already usual, the measuring arrangement is connected with the wire-processing machine, it is possible to reliably prevent conductor crimps or other measurement objects from being produced with measurement data that are recognized as erroneous.

With the camera system, further parameters of the measurement object can be measured, for example the crimp width, the overhang of the brows, the position of the measuring point, the position of the wire insulation, the color of the wire insulation, and/or the wire diameter.

The measurement accuracy of the optically determined parameters can be increased in that the measuring arrangement estimates, by means of other parameters or measurement dimensions, the distance by which the measurement points are separated and mathematically compensates the resulting perspective distortion.

With the aid of mirrors, a single camera can photograph the conductor crimp or another measurement object from various directions, which relative to solutions with a plurality of cameras reduces the costs. The mirrors can be so arranged that the measurement object can be photographed sharply from various directions simultaneously.

The vision system can control various lightings of the measurement object so that the image analysis is simplified (light in horizontal direction, also known as “side light”) or the image quality is improved (light in vertical direction, also known as “top light”). By means of mirrors that are present, the lighting can be deflected into the desired direction, for example for horizontal side light or vertical top light, without additional light sources.

The camera can additionally be used as a magnifying glass, or as a microscope, without a measurement being performed, which is useful when, for example, the operator wishes to inspect a crimp connection.

A further simplification of the handling can be achieved when the crimp contact is mounted with the conductor crimp in an apparatus that is movable in the measurement area. Such an apparatus can be guided manually or automatically in the measurement area. The apparatus can be embodied in such manner that the crimp contact can additionally be moved by rotation about the wire axis, so that the operator can view the conductor crimp at various points and from various angles without it leaving the image area.

On the digital image the operator can set measurement points and measure arbitrary points on the image. Additionally on the digital image, scales can be displayed which assist the operator with further measurements. Based on the measured parameters, for example crimp height and/or crimp width, the vision system can calculate the size of the maximum measurement error based on the perspective distortions.

The image of the measurement object is a projection in vertical direction and a projection in horizontal direction. Both projections are recorded by a camera simultaneously. The projection in vertical direction is further also referred to as “shadow image of the measurement object from below” and the projection in horizontal direction is further also referred to as “shadow image of the measurement object from the side”.

In a variant embodiment, from all image data that are received, the vision system can determine as parameter further parameters or measurement values, for example the width of the conductor crimp, or of another part of the crimp contact, or the position of the wire conductor, or of the edge of the wire insulation, in relation to the crimp contact.

As stated above, in the case of a crimp contact the vision system can, for example, in addition to determining the crimp height by means of a dial gauge or a height-measuring instrument, determine the crimp height from the image data. Since the optically evaluated shadow image always determines the maximum dimensions of the measurement object, whereas the dial gauge measures at points, the correct crimp height can be compared with the maximum extent of the measurement object. A greater crimp height indicates a crimp connection with impermissibly projecting brows.

Instead of a camera with plane image sensor, line sensors can also be used which scan the lines. Instead of line sensors, position-sensitive device (PSD) sensors can also be used which generate the analog signals that correspond to the positions of the shadows on the lines in the vertical and horizontal view.

Instead of a camera with lens, a point-shaped light source or laser beam can project the shadow image without lens onto the image sensor or sensors.

With the measuring arrangement together with the vision system the following advantages are obtained:

Erroneous measurements are recognized and avoided. The measurement on the conductor crimp takes place under reproducible conditions. In addition to the crimp height, further parameters or measurement dimensions can be determined. Simultaneous with the measurement, the operator can perform the optical check of the crimp connection. At the instant of measurement, the measurement object and the measurement situation are stored as a digital image. The measurement can be documented for quality purposes, subsequently examined, and traced. At the instant it is photographed, the measurement object is held at a specific location, focusing thereby becomes unnecessary and no blurring due to movement occurs. Manual initiation of the measurement is obviated, the operator has both hands free, he can, for example, bring the conductor crimp into the measurement position more rapidly and more precisely. Thanks to the optical enlargement, the measurement object and the measurement position can be better evaluated. The measuring arrangement can also be used as an optical enlargement device with image-capturing function and as an aid to measurement. The optical enlargement delivers images of views from various angles without the conductor crimp that is being observed needing to be moved.

The measuring arrangement is explained in more detail by reference to the attached figures.

Shown are in

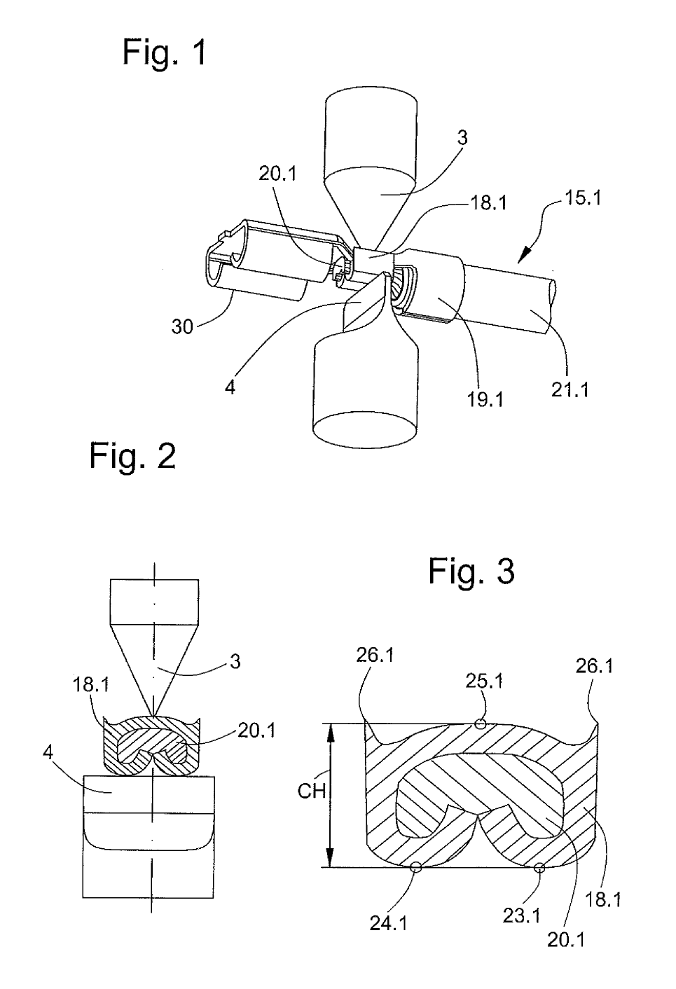

FIGS. 1 and 2

a diagrammatic representation of a mechanical three-point crimp-height measurement;

FIG. 3

a conductor crimp in cross section;

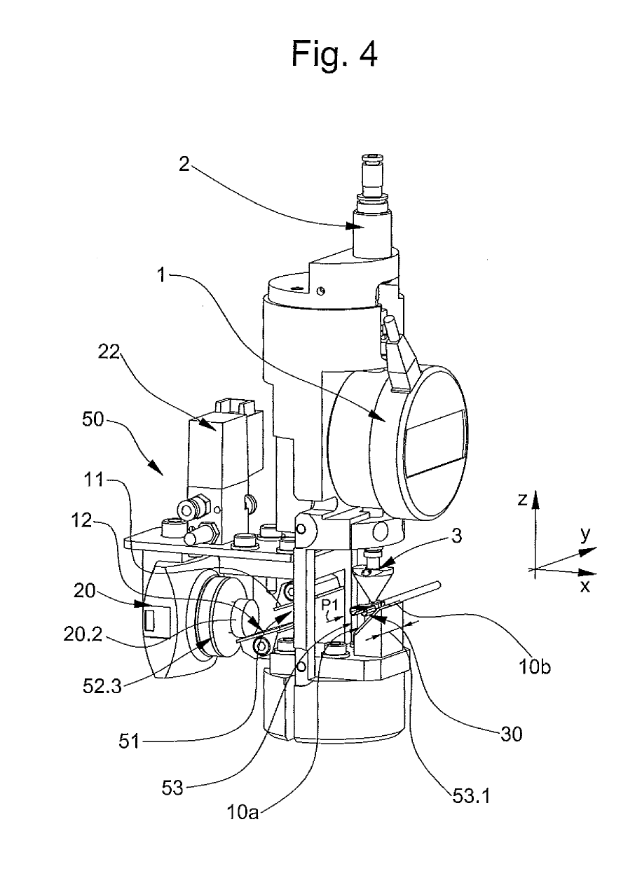

FIG. 4

a measuring arrangement for measuring a crimp contact;

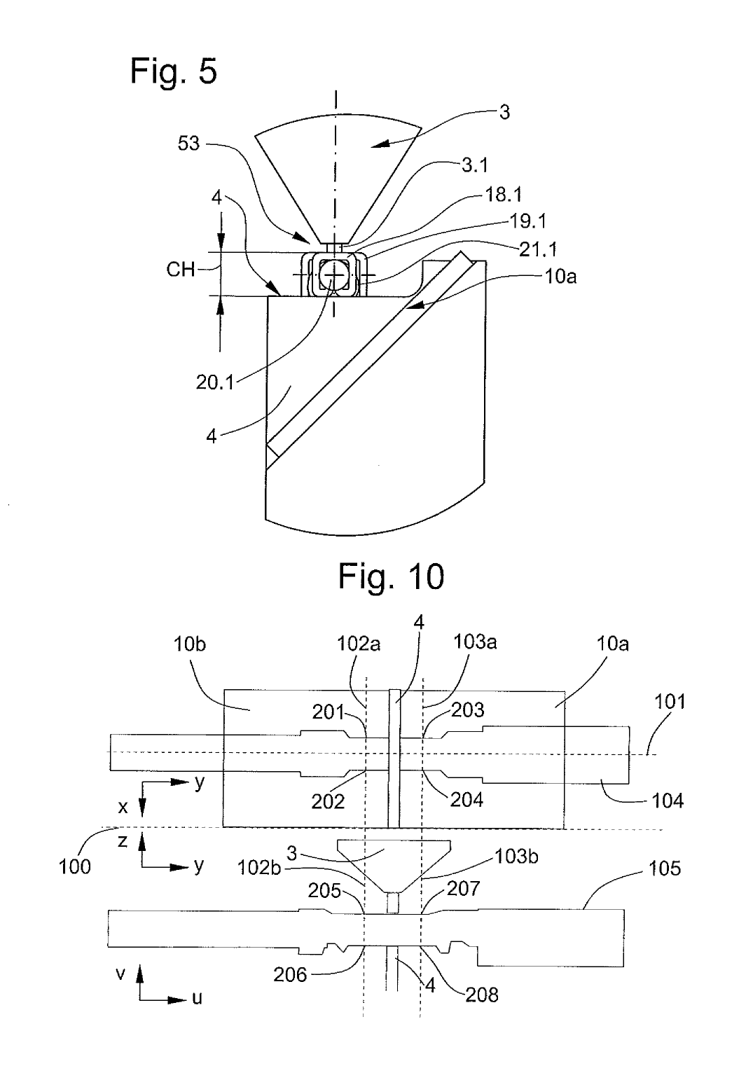

FIG. 5

details of a measurement range;

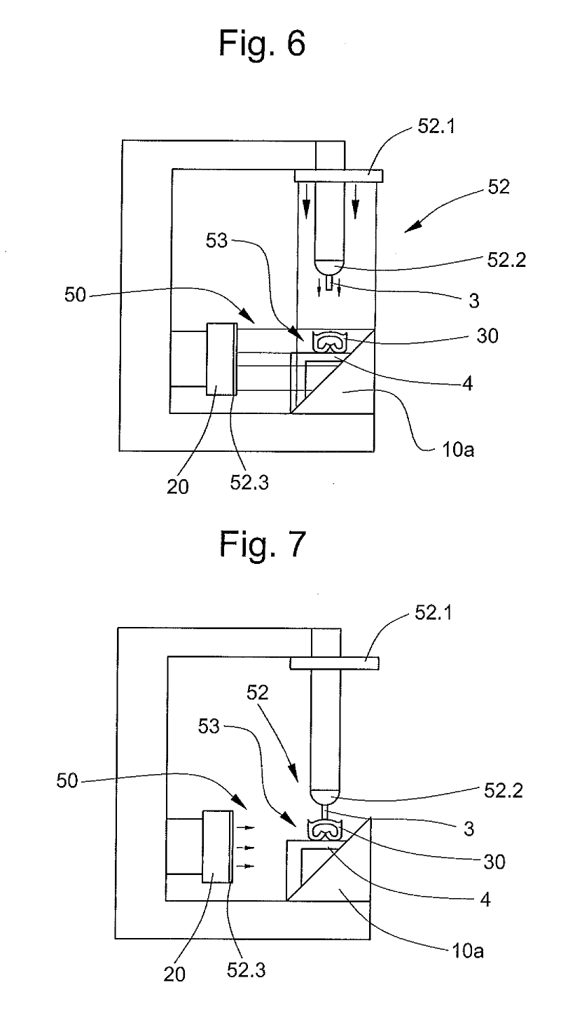

FIGS. 6 and 7

the measuring arrangement with light sources;

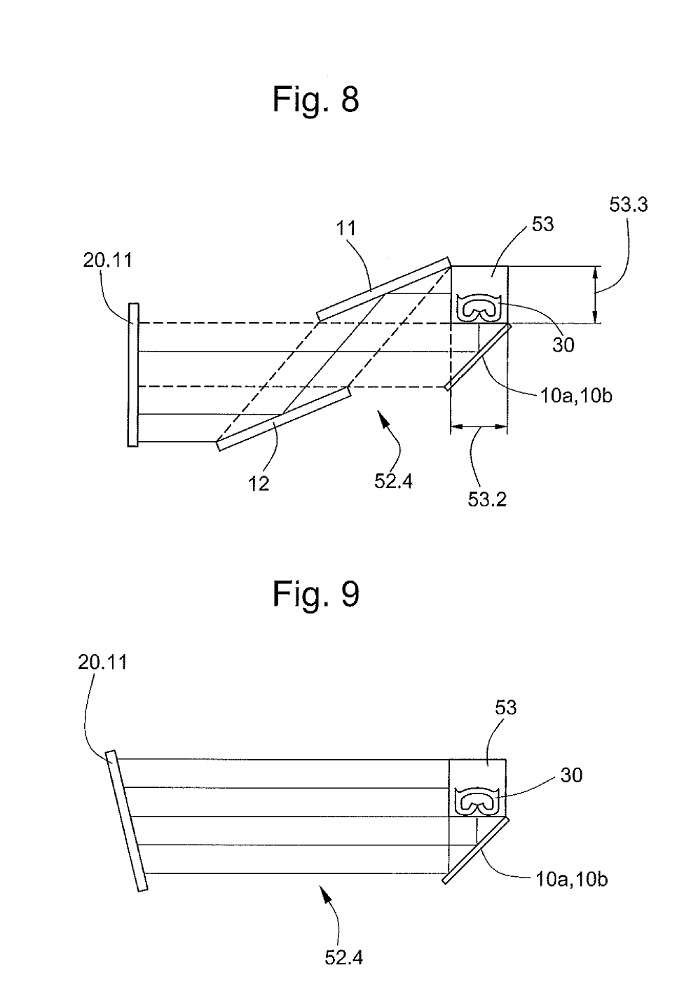

FIG. 8

an optical path of the measuring arrangement;

FIG. 9 a variant of the optical path;

FIG. 10

an image of the crimp contact; and

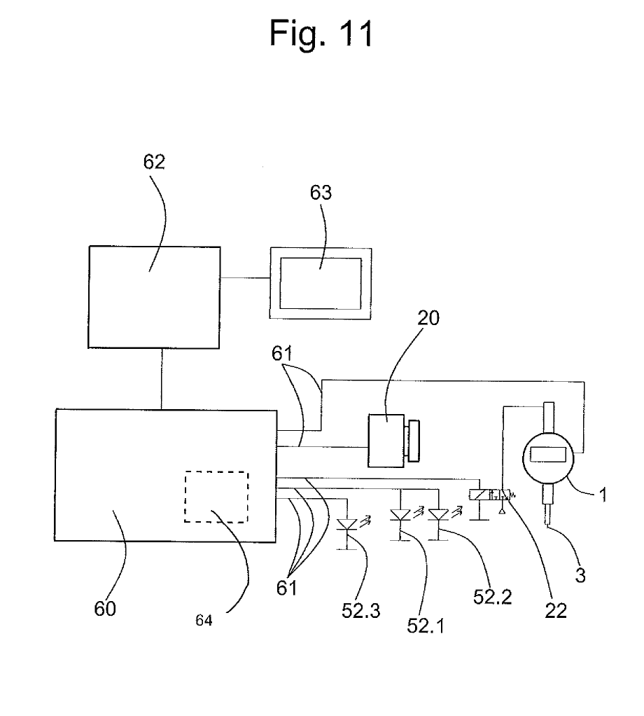

FIG. 11

a block circuit diagram of a vision system for controlling the measuring arrangement.

FIG. 1 and FIG. 2 show a diagrammatic representation of a three-point crimp-height measurement by means of measurement sensors. The crimp contact 30 that is pressed onto a wire 15.1 has a conductor crimp 18.1 and an insulation crimp 19.1, the conductor crimp 18.1 embracing a wire conductor 20.1 and the insulation crimp 19.1 embracing a wire insulation 21.1. In the crimping operation, conductor crimp 18.1 and insulation crimp 19.1 are plastically deformed and, by means of the crimping die and crimping anvil, pressed into the form shown. As first measurement sensor, a first blade 4 is in contact with one side of the conductor crimp 18.1. As second measurement sensor, a point 3 is in contact with the other side of the conductor crimp 18.1. The position of the blade 4 can be measured by means of a measuring device. The position of the point 3 can be measured by means of the measuring device. The difference between the two positions corresponds to the crimp height CH that is shown in FIG. 3.

FIG. 3 shows a cross section of the conductor crimp 18.1 with the contact points of the measurement sensors that are relevant for the three-point measurement of the crimp height. On the one side of the conductor crimp 18.1, at a first point 23.1 and at a second point 24.1, the blade 4 is in contact with the conductor crimp 18.1. On the other side of the conductor crimp 18.1, at a third point 25.1, the point 3 is in contact with the conductor crimp 18.1. Designated with 26.1 are burrs that come into being on the other side of the conductor crimp 18.1 during the crimping operation, mainly as a result of increasing wear of the crimping die and the crimping anvil. Determination of the crimp height by means of the blade 4 on the one side and the point 3 on the other side of the conductor crimp 18.1 is not falsified by the burrs 26.1. The crimp height CH results from the distance between the one side of the conductor crimp 18.1 that is defined by the first point 23.1 and the second point 24.1 and the other side that is defined by the third point 25.1.

FIG. 4 shows a measuring arrangement 50 for accepting and evaluating a crimp contact 30 in a measurement area 53. A camera 20 photographs the images of the measurement object in the measurement area 53 and a vision system evaluates these images. The camera 20 is, for example, a normal commercially available digital CCD camera. In addition, a height-measuring instrument 1 is provided by means of which at least one parameter of the measurement object, for example the crimp height CH of the conductor crimp of the crimp contact 30, is measurable. The crimp height CH is tactilely measured as shown in FIG. 1. The conductor crimp 18.1 rests on the blade 4 and the point 3 is lowered onto the conductor crimp 18.1 from above.

The camera 20 is arranged behind a measuring area 53 and can register the measuring area 53 with the crimp contact 30. A mirror arrangement 51 consists of a plurality of mirrors; arranged on a first side of the blade 4 is a first mirror 10a and on the other side of the blade 4 is a second mirror 10b. With the first mirror 10a and the second mirror 10b the camera 20 can see the measuring area 53, or crimp contact 30, on both sides of the blade 4 from below. With a third mirror 11 and a fourth mirror 12, the camera 20 can see the measuring area 53, or crimp contact 30, from the side.

The third mirror 11 and the fourth mirror 12 deflect the optical path of the side view in such manner that the distances between camera 20 and measurement area 53 for the view from the side and the view from below are of equal size, so that the camera 20 can photograph both views sharply simultaneously. The camera 20 is so aligned that both views are visible simultaneously on an image sensor 20.11 of the camera 20.

The view from below is a vertical projection of the measurement object, the view from the side is a horizontal projection of the measurement object.

The camera 20 transmits continually, for example at a rate of 25 images per second, the image data to the image-processing vision system (not shown here), which explains and evaluates the image data as explained further below and generates corresponding control signals (cf. FIG. 11 below).

FIG. 5 shows a cross section through the conductor crimp 18.1 that is arranged in the measurement area 53 in front of the blade 4 from the direction that is shown symbolized with an arrow P1 in FIG. 4. The conductor crimp 18.1 rests on the blade 4, and the point 3 presses onto the conductor crimp 18.1 with a pin 3.1. Visible in front of the blade 4 is the first mirror 10a, the second mirror 10b lies behind the blade 4 and is not visible.

The vision system can control various lightings of the measurement object so that the image analysis is simplified (light in horizontal direction, also known as “side lighting”), or the image quality is improved (light in vertical direction, also known as “top lighting”).

As shown in FIG. 6 and in FIG. 7, an illuminator 52 consists of a first light source 52.1, a second light source 52.2, and a third light source 52.3. The first light source 52.1 and the second light source 52.2 illuminate the measurement area 53 from above, the first light source 52.1 illuminating the measurement area 53 concentric with the point 3, and the second light source 52.2 illuminating the surface under the point 3. The first light source 52.1 and the second light source 52.2 can also (with corresponding shaping of the point 3 as shown in FIG. 4) be embodied as a light source. The third light source 52.3 is arranged concentric with the lens 20.2 of the camera 20 and illuminates the measurement area 53 from the side.

The image of the measurement object, or of the crimp contact 30, is a projection in vertical direction and a projection in horizontal direction. Both projections are recorded simultaneously by the camera 20. The projection in vertical direction is further also referred to as “shadow image of the measurement object from below” and the projection in horizontal direction is further also referred to as “shadow image of the measurement object from the side”.

The light source 52.1, 52.2 of the point 3 is a light cone and, with the optical path via the third mirror 10a and via the fourth mirror 10b, the camera 20 can see the measurement area 53, or the crimp contact 30, from the side and from below as a shadow image with light background (see also FIG. 10). The light cone consists of a translucent, diffuse material into which LEDs are built in such manner that the light is emitted uniformly. To reduce interference from ambient light, the exposure time of the camera 20 is set very short (for example 100 microseconds) and the LEDs are only activated with a high current during the short exposure time, and the measuring area 53, or crimp contact 30, is thereby illuminated with a higher light intensity than the ambient light. The average light intensity and the average current through the LEDs nonetheless remain low, so that the operator is not dazzled and the LEDs are not overloaded.

If the operator manually moves a conductor crimp 18.1, or a crimp contact 30 that is crimped onto a wire 15.1, into the measuring area 53, with the procedure that is described below the vision system constantly checks whether the measurement object in the view from below is located in the prescribed position. As soon as this is the case, the vision system activates an actuator 2, for example a pneumatic cylinder 2 that is operated by means of valve 22, which lowers the point 3 onto the measurement object 30. On the measurement object, which is now held in the measuring position, the vision system checks whether the measurement object is also in a correct measuring position in the side view. If the measurement object is outside the correct measuring position, the vision system activates the actuator 2 in the opposite direction and the point 3 is moved upward again, By means of signal lamps, the vision system generates a corresponding response for the user. Also as response for the user, the vision system can display on a screen a camera image with error messages.

The aforesaid multi-step measuring procedure (first check the view from below, then move the measuring point, then evaluate the view from the side) has the advantage that the operator need not hold the measurement object correctly in all degrees of freedom simultaneously. The sequence can, however, also be reversed, or all parameters can be checked simultaneously and only then the point 3 moved.

If, as explained further below, the vision system detects that the measurement position in both views is correct, the measurement on the measurement object, or the measurement of at least the crimp height, is initiated, and the measurement value is read out of the height-measuring instrument 1 via a digital interface. At the same time, the camera image at the instant of measurement can be saved and linked with the measurement data.

The vision system can switch on the third light source 52.3, which illuminates the measurement object from the direction of the camera 20 so that the measurement object is better recognizable. This image can also be saved and linked with the measurement data. For purposes of quality assurance also at a later date, with the saved measurement data and the associated images the circumstances under which the measurement on the measurement object was performed can be ascertained.

The vision system can control various illuminations of the measurement object so that the image analysis is simplified (light in horizontal direction, known as “side lighting”) or the image quality is improved (light in vertical direction, also known as “top lighting”).

FIG. 8 shows an optical path 52.4 for photographing the measurement object (crimp contact) 30 on the image sensor 20.11 of the camera 20. With the aid of the mirror arrangement 51, consisting of the first mirror 10a, the second mirror 10b, the third mirror 11, and the fourth mirror 12, one single camera 20 can photograph the measurement object from various directions. The mirrors 10a, 10b, 11, 12 are arranged in such manner that on the image sensor 20.11 the measurement object is displayed sharply from various directions (from below and from the side) simultaneously. The size of the measurement area 53 is determined by the first projection 53.2 of the first mirror 10a and the second mirror 10b, and by the second projection 53.3 of the third mirror 11 and by the mirror width 53.1.

FIG. 9 shows a variant embodiment of the optical path 52.4 in which the measurement object is also displayed sharply op the image sensor 20.11 from various directions (from below and from the side) simultaneously. The different beam length between the view from the side and the view from below is compensated with the diagonally aligned image sensor 20.11. Also possible is a two-part image sensor which runs parallel to the measurement object in which the part for the view from below is closer to the measurement object.

The image of the measurement object is a projection in vertical direction and a projection in horizontal direction. Both projections are photographed by the camera 20 simultaneously. The projection in vertical direction is further also referred to as “shadow image of the measurement object from below” and the projection in horizontal direction is further also referred to as “shadow image of the measurement object from the side”.

FIG. 10 shows an image of a measurement object, for example of a crimp contact 30. The crimp contact 30 is displayed as shadow image as it is seen by the camera 20. With the aid of the mirror arrangement 51 the measurement object is displayed from various directions simultaneously, viz. as shadow image 104 from below and as shadow image 105 from the side. Lines 100, 101, 102a, 102b, and 103a, 103b, as well as coordinate systems, are overlaid by the vision system and serve to evaluate the position of the measurement object in the measurement area 53.

Above the line 100 the shadow image 104 of the crimp contact 30 is displayed from below, and below the line 100 the shadow image 105 is shown from the side. The line 101 describes the ideal axis of the measurement object, or of the crimp contact 30, in the shadow image 104 from below, in which line 101 the crimp contact 30 ideally lies perpendicular to the blade 4 and centrally to the point 3.

For the measurement operation the following preconditions apply:

The crimp contact must be so positioned in the x direction that in the x direction the point 3 is central to the conductor crimp 18.1 so that the point 3 measures at point 25.1. Further, the crimp contact 30 must be so rotated about the z axis that the longitudinal axis of the wire lies perpendicular to the plane of the blade 4. The crimp contact 30 must be so positioned in the y direction that the point 3 and the blade 4 measure on the flat part of the conductor crimp 18.1. The conductor crimp 18.1 should touch the blade at the points 24.1 and 23.1 of FIG. 3.

The operator prepares the measurement object, or the crimp contact 30, by cutting the wire-end 15.1 as short as possible so that he can hold it tightly with his fingers. He then lays the crimp contact 30 with the points 24.1 and 23.1 facing down (see FIG. 3) on the blade 4, and positions it by eye so that the longitudinal axis of the wire runs approximately horizontally and perpendicular to the blade 4, and the blade 4 touches the conductor crimp 18.1 in its flat part. The operator now moves the crimp contact 30 in the x direction to the point 3 until the measurement operation is initiated and the point 3 is moved downward and, with a defined force that is generated by means of the actuator 2, grips the crimp contact 30 between the point and the blade. The blade 4 has horizontal measuring surfaces whereby, when the crimp contact 30 is gripped, a torque is generated in the x axis and the crimp contact 30 is pressed into the horizontal position.

The vision system, as explained further below, now checks the aforesaid conditions, If all conditions are fulfilled, the vision system reads out the height-measuring instrument 1 and transmits the data, together with the current image of the camera 20, to a machine control. The machine control saves the measurement data and the associated image on a mass storage device.

Otherwise, the vision system transmits the fault situation to the machine control, and this presents the fault to the operator via the screen. In addition, the vision system will raise the point 3 again. The positioning of the crimp contact 30 can then be repeated.

An image is projected onto the sensor 20.11 of the camera 20 as shown in FIG. 10. A system of coordinates (u, v) is also defined on the image.

Via a serial data connection the projected brightness values are continually, for example with 20 images per second, transmitted to the vision system. Each arriving image is subjected to the following processing steps by means of the vision system:

Each image point has a brightness value h. With a suitable threshold value hs, the image points are assigned to the categories “Background” and “Shadow”. The image points whose brightness value h<hs belong to the category “Shadow”, those with h>=hs to the category “Background”.

To determine the position of the measurement object from below, the following process steps are performed by means of the vision system:

Starting at the upper edge of the image, the vision system seeks with decreasing coordinate v on the line 102a the first image point that belongs to the category “Shadow”. This point is temporarily saved as point 201 with the coordinates (u201, v201).

Starting at line 100, the vision system seeks with increasing coordinate v on the line 102a the first image point that belongs to the category “Shadow”. This point is temporarily saved as point 202 with the coordinates (u202, v202).

Similarly on line 103a, the points 203 with (u203, v203) and 204 with (u204, v204) are determined and temporarily stored.

For the aforesaid conditions to be fulfilled, on a measurement object that is mirror-symmetrical relative to line 101, certain values that are calculated mathematically from the aforesaid coordinates must be fulfilled. Small deviations are tolerated. Only when the aforesaid conditions are fulfilled does the vision system trigger the point 3 by means of the valve 22. The crimp contact 30 is now gripped firmly in the measuring arrangement 50.

The vision system checks further conditions on the images that continue to arrive from the camera 20:

For this purpose, the points 201, 202, 203 and 204 as described above are determined anew and the aforesaid conditions are checked, since the point 3 of the measurement object may possibly have moved during closing. In addition, similar to the points 201, 202, 203, and 204, the points 205 with (u205, v205), 206 with (u206, v206), 207 with (u207, v207), and 208 with (u208, v208) are determined, and values that are determined by the coordinates are calculated. Small deviations are tolerated. Checking of the aforesaid conditions is refined further in that the lines 102b and 103b are several times slightly displaced in the u direction and the evaluation is repeated each time. If all of the aforesaid conditions are constantly fulfilled over several, for example five, successively arriving images, the vision system recognizes the measurement as valid.

The crimp height CH can be measured not only with the height-measuring instrument 1, but—though with reduced accuracy—also from the shadow images.

The optically measured height hopt is determined mathematically from the coordinates of the points 205, 206, 207, 208 at the position of the point 3 on the lines 102b and 103b. The height hopt corresponds to the maximum distance between the line through 24.1 and 23.1 and one of the three points 26.1, 26.1 and 25.1 of FIG. 3.

On the other hand, the measuring gauge with the point 3 only measures the distance CH between the line through 24.1 and 23.1 and point 25.1 of FIG. 3.

In a correctly processed crimp contact 30, the burrs 26.1 should not project beyond the point 25.1 of FIG. 3. This can be checked by the vision system through comparison of the measurement values hopt and CH: if hopt>CH, the conclusion can be drawn that at least one of the two burrs 26.1 projects beyond the point 25.1 of FIG. 3. A correct crimp height measurement is nonetheless possible, but the vision system can, for example, generate a corresponding warning and transmit the information with the measurement data to the machine control.

The measurement value or measured crimp height CH as parameter can be transmitted to the wire-processing unit which, based on the measurement value, for example, automatically adjusts the crimp position of a crimp press.

The measurement object, for example the crimp contact 30, can, instead of manually, be brought mechanically, for example by means of a gripper-like apparatus, into the measuring area 53. The measurement operation can thereby be fully automated. The apparatus can be so embodied that the measurement object is additionally movable rotatably around the wire axis or along the wire axis.

As measurement object, instead of the crimp contact 30, for example, also a crimp sleeve or a blade contact or a seal or a cap with color code, which can be pushed onto the end of the wire insulation 21.1, can be positioned and measured. Instead of the crimp height CH as measurement parameter, for example the position of the measurement object on the wire conductor 20.11, or the diameter of the measurement object, can be measured. Instead of the height-measuring instrument 1, another measuring apparatus, for example a micrometer or a digital dial gauge, can be used, the type of the measurement sensor being selected depending on the measurement object and depending on the type of the measurement.

In principle, the measurement apparatus can also be used for small measurement objects from the watchmaking industry.

FIG. 11 shows a block circuit diagram of the vision system 60 for control of the measuring arrangement 50. The vision system 60 consists essentially of a calculator, a working memory, a program memory, a data store, a power supply, inputs/outputs for connection with the measuring arrangement 50, for example serial connectors 61 to the valve 22, to the camera 20, to the height-measuring instrument 1, and to the illuminator 52 with the light sources 52.1, 52.1 and 52.3. The aforesaid procedure for image evaluation is stored as software in the program memory and executed by the calculator. The vision system 60 comprises an evaluation and comparison device 64, with which, based on the images taken by the camera, the actual position of the crimp contact is determined and the actual position can be compared with a reference position of the crimp contact. Further, the vision system 60 is in electronic connection with a machine control 62 with a screen 63 which serves the operator as visual interface. The machine control 62 controls, for example, a wire-processing machine for manufacturing the crimp contact shown in FIG. 1.

1. Measuring arrangement (50) to determine at least the crimp height (CH) of a conductor crimp (18.1) of a crimp contact (30), consisting of a camera (20) for photographing images (104, 105) of the crimp contact (30) in a measurement area (53) and comprising a vision system (60) for evaluating the images (104, 105) and consisting of a measuring apparatus (1) that is connected with the vision system (60) for tactile measurement of the crimp height (CH) of the conductor crimp (18.1).

2. Measuring arrangement (50) according to claim 1, wherein the vision system (60) comprises an evaluation and comparison device (64) with which, by reference to the images (104, 105) that are photographed by the camera, the actual position of the crimp contact (30) can be determined and the actual position compared with a reference position of the crimp contact (30).

3. Measuring arrangement (50) according to claim 1 or 2, wherein the vision system (60) is programmed in such manner that only when all predetermined requirements for the position of the crimp contact (30) have been fulfilled is a measurement of the crimp height (CH) of the conductor crimp (18.1) performed by the measurement apparatus (1).

4. Measuring arrangement (50) according to one of claims 1 to 3, wherein the measurement apparatus (1) has movable measurement sensors (3, 4) which lie opposite each other and are movable relative to each other by means of an actuator (2).

5. Measuring arrangement (50) according to one of claims 2 to 4, wherein the vision system (60) that is connected with the actuator (2) is programmed in such manner that, if the predefined requirements for the position of the crimp contact (30) do not prevail, or if the predefined requirements for the position of the crimp contact (30) are not fulfilled, while the conductor crimp (18.1) that is positioned in the measurement area (53) is contacted by the measurement sensor (3, 4), the measurement sensors (3, 4) automatically move back into a rest position.

6. Measuring arrangement (50) according to one of claims 1 to 5, wherein a mirror arrangement (51) is provided with whose aid different views of the crimp contact (30) can be displayed on an image sensor (20.11) of the camera (20).

7. Measuring arrangement (50) according to claim 6, wherein the mirror arrangement (51) has a first and a second mirror (10a, 10b) to display the crimp contact (30) from below.

8. Measuring arrangement (50) according to claim 7, wherein the measuring apparatus (1) contains as first measurement sensor a blade (4) which abuts perpendicularly against the first and second mirror (10a, 10b) and is arranged between the first and second mirror (10a, 10b).

9. Measuring arrangement (50) according to claim 7 or 8, wherein the mirror arrangement (51) has a third and a fourth mirror (11, 12) to display the crimp contact (30) from the side.

10. Measuring arrangement (50) according to one of claims 1 to 9, wherein an illuminator (52) that is controllable by means of the vision system (60) is provided to illuminate the different views.

11. Wire-processing machine with a measuring arrangement (50) according to claims 1 to 10.

12. Procedure for determining at least the crimp height (CH) of a conductor crimp (18.1) of a crimp contact (30) according to the following steps:
a) bring the crimp contact (30) into a measuring area (53),
b) photograph images (104, 105) of the crimp contact (30),
c) from the images (104, 105), determine at least the position of the crimp contact (30) in the measurement area (53),
d) if all predefined requirements for the position of the crimp contact (30) are fulfilled, tactilely measure the crimp height (CH) of the conductor crimp (18.1), and
e) if the requirements for the position of the crimp contact (30) are not fulfilled, repeat steps a) to c).

13. Procedure according to claim 12 wherein first, if all predefined requirements for the position of the crimp contact (30) are fulfilled, a measurement signal for the crimp height (CH) of the conductor crimp (18.1) is generated by the measurement apparatus (1).

14. Procedure according to claim 12 or 13, wherein if the requirements for the position of the crimp contact (30) are not fulfilled, a measurement apparatus for tactile measurement of the crimp height (CH) of the conductor crimp (30) is automatically placed in a rest position.

15. Procedure according to one of claims 12 to 14, wherein each image element of the images is evaluated as “Shadow” or “Background” depending on the brightness value, and wherein vertical and horizontal lines (100, 101, 102a, 102b, 103a, 103b) and a system of coordinates (u, v) are laid over the images for the purpose of evaluating the position of the crimp contact (30) in the measurement area (53).

16. Procedure according to claim 15, wherein the coordinates on the lines of the image points that are evaluated as shadows are determined and, from the coordinates, the position of the crimp contact (30) relative to the lines is determined.

17. Procedure according to claim 15 or 16 wherein, from the coordinates, the parameter (hopt) of the crimp contact (30) is determined and compared with the measured crimp height (CH) of the conductor crimp (30).

18. Procedure according to claim 17, wherein, for automatic setting of the wire-processing machine that manufactures the crimp contact (30), the parameter (hopt, CH) of the crimp contact (30) is transmitted to the machine.
